(19) United States
(12) Patent Application Publication
(10) Pub. No.: US 2003/0012630 A1
(43) Pub. Date: Jan. 16, 2003

(54) Device to assist the changing of a vehicle wheel

(76) Inventor: Carl Edward Brabson JR., Owings Mills, MD (US)

Correspondence Address: Royal W. Craig, Law Offices of Royal W. Craig, Suite 1319, 210 N. Charles Street, Baltimore, MD, 21201, US

(21) Appl. No.: 09/905,505

(22) Filed: Jul. 13, 2001

(51) Int. Cl. B65G 7/00; B60B 29/00

(52) U.S. Cl. 414/429

(57) ABSTRACT

An device designed to assist in changing a vehicle wheel is herein disclosed. The ergonomically-designed device is fabricated of a variety of strong, rigid materials (e.g. steel) to provide the durability required by the nature of its usage. The three main sub-assemblies of the present invention include a frame assembly, a seat assembly, and a wheel support assembly. The tubular frame assembly rides on casters and preferably includes a cross-member on which the elements of the wheel support assembly are mounted. A frame-mounted seat provides the user with an ergonomic means to position himself/herself for placing the wheel on, or removing it from, the axle hub. A tray attached to the tubular frame assembly provides an area where the user's tools or the wheel's lug nuts may be temporarily stored.

### BACKGROUND OF THE INVENTION

1. Field of the Invention

The present invention relates to devices utilized in changing the wheels of automobiles and light trucks and, more particularly, to an improved design for a device possessing the means to support a vehicle wheel (i.e. the combination, or assembly, of a rim and a tire) off of the ground (1) during installation on, or removal from, an axle hub, and (2) while transporting the wheel from/to the vehicle for replacement, repair, etc.

2. Description of the Background

The wheels utilized on automobiles and light trucks can be quite heavy. In the course of a typical workday, individuals employed in companies specializing in wheel/tire sales (i.e. installation) or maintenance are repeatedly called upon to remove and/or install, as well as transport about the facility, a significant number of vehicle wheels. This presents the owners of those businesses with certain ergonomic challenges that must be overcome to maintain a safe, healthy working environment (e.g. avoidance of worker injuries due to lifting and/or repetitive motion syndrome).

The present inventors are not the first to notice this deficiency and devices designed to assist with the changing of automobile and light truck wheels are not unknown in the art. Variations on the theme are found in U.S. Pat. No. 3,828,955 to Harkey, U.S. Pat. No. 3,847,294 to Davenport, U.S. Pat. No. 4,256,430 to Pugel, U.S. Pat. No. 4,872,694 to Griesinger, and U.S. Pat. No. 5,348,438 to Roberts. The various designs include features such as a foot plate (e.g. Griesinger '694, Roberts '438), a knee plate (e.g. Roberts '438), or a seat (e.g. Pugel 430) so that the operater may use his/her body weight to pivot the device as a wheel is on- or off-loaded. One device even provides the ability to accommodate more than one wheel at a time (e.g. Davenport '294).

U.S. Pat. No. 3,828,955 to Harkey discloses a tire changing tool that includes a lever plate having a flat surface terminating at an upturned lip for supporting a tire, a solid handle extending upwardly from the lever plate, and a pair of wheel assemblies supporting the lever plate with soft rubber tires designed to offer some resistance to rotation such that the assembly will not freely roll.

U.S. Pat. No. 3,847,294 to Davenport discloses a dual wheel remover which is mounted on a combination of fixed and swivel type casters and possesses an adjustable tilting feature that allows wheels to be easily removed from a vehicle and securely transported without the need for the operator of the assembly to physically handle the wheels.

U.S. Pat. No. 4,256,430 to Pugel discloses a wheel change mechanism comprising a base member which is movable along a support surface, wheel support members that extend from one end of the base member, and a seat positioned at the opposite end of the base member for pivoting the base member when a force is exerted thereon.

U.S. Pat. No. 4,872,694 to Griesinger discloses a wheel mounting device adapted to lift and position a wheel by means of two horizontal parallel rollers, two vertical parallel rollers, a caster-mounted main-frame plate with extensions forming a triangle, and a foot plate positioned at the apex of the triangle.

U.S. Pat. No. 5,348,438 to Roberts discloses a vehicle wheel changing aid that includes a rocker base having an operator end, a wheel receiving end, a bottom facing pivot surface adapted to contact the ground as the rocker base is pivoted, a plurality of spaced apart rollers for use in accurately aligning the wheel lug openings with the lugs on the axle hub, and a knee/foot bearing pad positioned towards the operator end of the base that permits a wheel to be raised or lowered from the axle hub by application of the operator's knee/foot.

However, the prior art still offers room for improvement. All of the aforementioned devices introduce some degree of vertical tilt with respect to the vehicle which makes it more difficult to remove the tire from the lugs of the wheel hub. Moreover, none of the foregoing patents address the ergonomic issues required for long-term, repetitive use in a commercial environment. Therefore, there exists a need for a device possessing improved, adjustable means for lifting a vehicle wheel while providing the comfort and utility required for long-term, repetitive use.

### SUMMARY OF THE INVENTION

It is, therefore, the primary object of the present invention to provide an improved device to assist the changing of a vehicle wheel that is designed to lift the wheel vertically from the lugs of the axle hub, without any degree of tilting, during the removal/replacement process.

It is another object to provide an improved device to assist the changing of a vehicle wheel that possesses a wheel support assembly that can be adjusted to accommodate wheels of different sizes/diameters.

It is yet another object to provide an improved device to assist the changing of a vehicle wheel that includes a place for the operator to temporarily store a plurality of lug nuts in addition to his/her tools.

It is still another object to provide an improved device to assist the changing of a vehicle wheel that possesses a simple, ergonomically-correct, durable design that can be manufactured economically.

In accordance with the above objects, one embodiment of the present invention is an ergonomically-designed device fabricated of a variety of strong, rigid materials (e.g. steel) to provide the durability required by the nature of its usage. The three main sub-assemblies of the present invention include a frame assembly, a seat assembly, and a wheel support assembly. The tubular frame assembly rides on casters and preferably includes a cross-member on which the elements of the wheel support assembly are mounted. A frame-mounted seat provides the user with an ergonomic means to position himself/herself for placing the wheel on, or removing it from, the axle hub. A tray attached to the inside of the tubular frame assembly creates an area where the user's tools or the wheel's lug nuts may be temporarily stored.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a top perspective view of a device 15 designed to assist the changing of a vehicle wheel according to a first embodiment of the present invention.

FIG. 2 is a front perspective view of the device 15 shown in FIG. 1.

FIG. 3 is a side perspective view of the device 15 shown in FIGS. 1 and 2.

FIG. 4 is a top, close up view of the adjustable wheel support roller assembly 70 as shown in FIG. 1.

FIG. 5 is a side perspective view of the device 15 of FIGS. 1-3 shown supporting a wheel 100 that has just been removed from (or, conversely, that is just about to be placed on) an axle hub 110.

### DETAILED DESCRIPTION OF THE PREFERRED EMBODIMENT

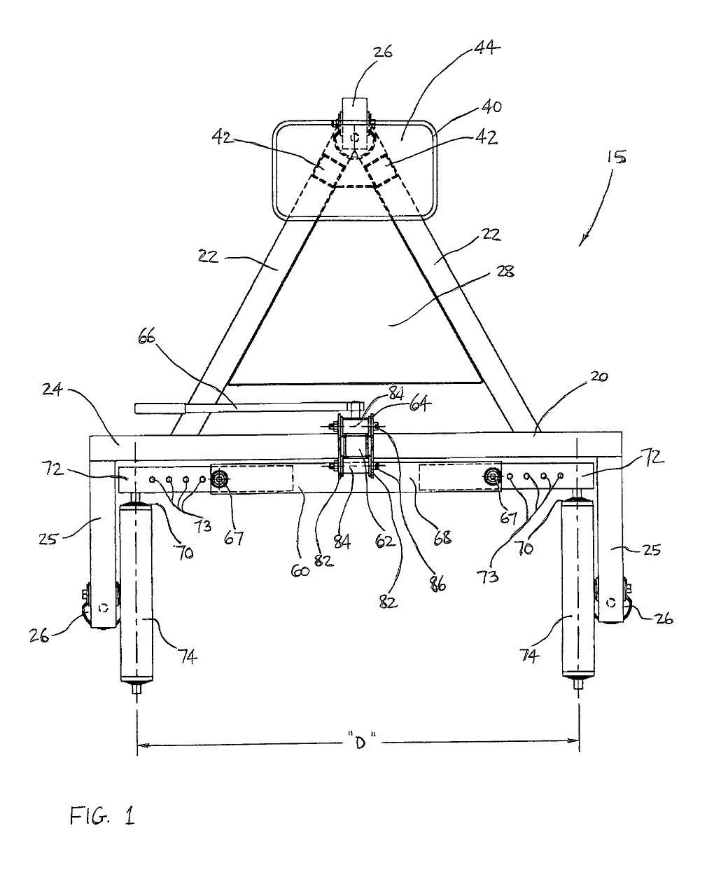

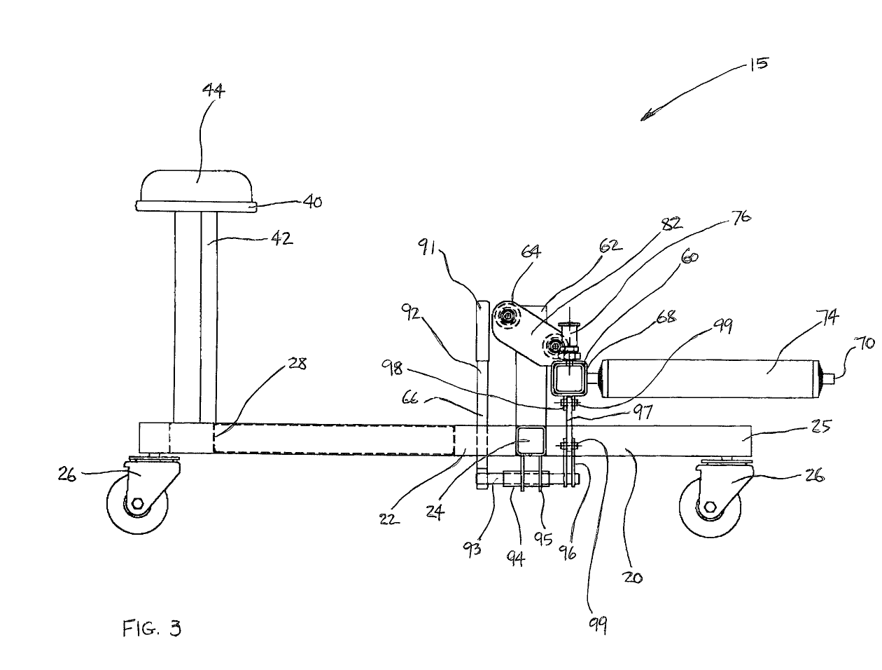

FIGS. 1, 2, and 3 show, respectively, top, front, and side perspective views of the device 15 to assist the changing of a vehicle wheel according to a first embodiment of the present invention. The three main sub-assemblies of the present invention include a frame assembly 20, a seat assembly 40, and a wheel support assembly 60.

The frame assembly 20 is preferably constructed of steel and/or another strong, rigid material. The frame assembly includes two divergent square tubular side members 22 joined at their apex, one square tubular cross-member 24 spanning the two side members 22, two square tubular extension members 25 protruding forwardly from the ends of the cross-member 24, three commercially available swivel-type casters 26, and one triangular sheet metal tray 28.

The side members 22 and the cross-member 24 are fixedly connected in a triangular configuration such as shown in FIG. 1. The extension members 25 are fixedly attached at both ends of the cross-member 24 perpendicular to the cross-member 24. One of the casters 26 is fixedly attached to the underside of the side members 22 proximate the point where the members 22 are joined. The other two casters 26 are fixedly attached to the underside of the distal ends of extension members 25. The tray 28 is fixedly attached to the inside surfaces of the side members 22. The triangular tray provides the user with a place to temporarily store lug nuts and/or his/her tools. It should be understood that frame configurations other than the triangle of FIG. 1 may be utilized.

The seat assembly 40 further comprises two upwardly-directed support legs 42 and a seating surface 44. The seat support legs 42 are preferably fabricated of steel or another strong, rigid material. The bottom end of each support leg 42 is fixedly attached to the top surface of the frame assembly 20 proximate the apex where the side members 22 are joined. The seating surface 44 may be a commercially available, vinyl covered, foam cushioned, seat assembly that is fixedly attached to the top ends of the support legs 42. The length of the support legs 42 is such that the seating surface 44 to allow the user to both (1) propel the device 15 with his/her feet while in a seated position, or (2) push the device 15 via placement of his/her hands on the seating surface 44 while standing or walking. Alternatively, the seat assembly 40 may be configured such that its height is adjustable within an ergonomically appropriate range.

The wheel support assembly 60 further comprises a vertical support member 62, vertical travel load bearing assembly 64, a lift control lever 66, a horizontal lift member 68, and two adjustable wheel support roller assemblies 70.

The vertical support member 62 and the horizontal lift member 68 are preferably constructed of square tubular steel stock (or another strong, rigid material). The vertical support member 62 is fixedly attached to the frame's cross-member 24 in a vertical orientation. The lift member 68 includes two vertically oriented holes 67 in its top surface (positioned proximate each of its ends).

The vertical travel load bearing assembly 64 comprises two side plates 82 and two commercially available roller assemblies 84. The side plates 82 are preferably constructed of steel (or another strong, rigid material) bar stock. The center shafts 86 of the roller assemblies 84 are fixedly attached proximate the ends of the plates 82 such that the shafts 86 are parallel and the space left between the surfaces of the rollers 84 is equivalent to the width of the vertical member 62. When installed in the fully assembled device 15, the load bearing assembly 64 straddles the vertical member 62 with opposing rollers 84 in rolling contact with the member 62 and the plates 82 fixedly connected to the top surface of the lift member 68, such that any movement of the member 68 is either straight up, or straight down.

The lifting assembly 66 comprises a handle 91, a lift lever 92, a shaft 93, a bearing assembly 94, a bearing support bracket 95, a lower link 96, an upper link 97, an upper link bracket 98, and two link pins 99. The lift lever 92 and the shaft 93 are preferably constructed of steel (or another strong, rigid material), round bar stock. The bearing support bracket 95, the upper link bracket 98, and the links 96, 97 are preferably constructed of steel (or another strong, rigid material), rectangular bar stock.

The commercially available handle 91 is fixedly attached at one end of the lift lever 92. The other end of the lever 92 is fixedly attached to one end of the shaft 93 such that the center axis of the lever 92 is perpendicular to the center axis of the shaft 93. The shaft 93 extends through and is rotatably supported by the commercially available bearing assembly 94. The bearing assembly 94 is fixedly attached to the bearing support bracket 95 which is, in turn, fixedly attached to the bottom surface of the cross-member 24. The other end of the shaft 93 is fixedly attached to one end of the lower link 96. The other end of the lower link 96 is rotatably connected to one end of the upper link 97. The other end of the upper link 97 is rotatably connected to the upper link bracket 98 which is, in turn, fixedly attached to the bottom surface of the lift member 68. The rotating connections between the links 96, 97 and the bracket 98 are facilitated by commercially available link pins 99.

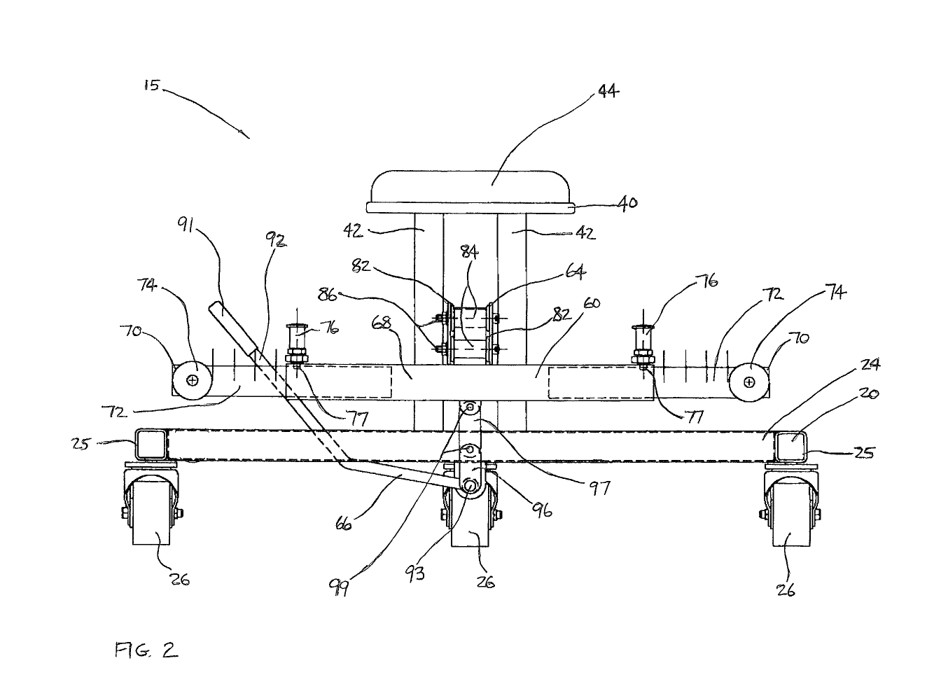

Vertical movement of the lift member 68 is provided by the lifting assembly 66 when the user exerts force on the lever 92. Force exerted on the lever 92 results in rotation of the shaft 93. Rotation of the shaft 93 causes the lower link 96 to pivot about the axis running through the center of the shaft 93. Due to the fixed connection of the support bracket 95 on the frame assembly 20, and the fixed connection of the upper link bracket 98 on the lift member 68, coupled with the limitations on the movement of the lift member 68 (i.e. up or down along a vertical axis only, imposed by the load bearing assembly's 64 contact with the vertical member 62 and connection to the lift member 68), any pivoting, or angular rotation, of the lower link 96 causes a corresponding angular rotation of the upper link 97. Any angular rotation of the links 96, 97 changes the effective length of the links 96, 97 along the vertical axis of movement of the lift member 68 causing a change in the elevation of the lift member 68 and anything attached to, or supported by it (e.g. a wheel). The elevation of the lift member 68 may be anything between the “up” position established when the links 96, 97 are aligned with the vertical axis (see FIG. 2), and the “down” position created when the links 96, 97 are oriented at angles approximately 45° from the vertical axis.

In contrast to that provided in the prior art (i.e. a lifting motion accompanied by some tilting of the wheel), this novel wheel support assembly 60 incorporates a straight, vertical lifting motion. There is no tilting of the wheel during the lifting procedure.

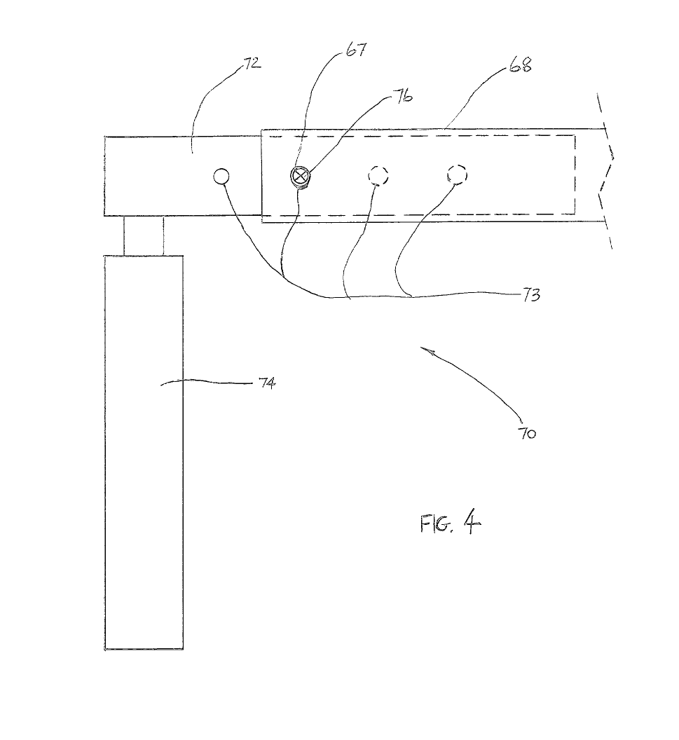

FIG. 4 is a close up view of the adjustable wheel support roller assembly 70 as shown in FIG. 1. Each adjustable wheel support roller assembly 70 includes an adjustment bar 72, a commercially available roller assembly 74, and a commercially available indexing plunger assembly 76. The adjustment bar 72 is preferably constructed of steel (or another strong, rigid material), square tubular stock and includes a plurality of regularly spaced holes 73 thorugh its top surface. The roller assembly 74 is fixedly attached at one end of the adjustment bar 72 such that the center axis of the roller 74 is perpendicular to the center axis of the bar 72, as well as being perpendicular to the center axes of the plurality of holes 73.

The bar 72 is slidably engaged with the horizontal lift member 68 such that the amount of interference, or overlap, between the two can be adjusted via an indexing plunger assembly 76 and the holes 67, 73. The plunger assembly 76 is fixedly attached to the top surface of the lift member 68 such that the spring-loaded, internal plunger 77 (see FIG. 2) protrudes through the lift member hole 67 and one of the adjustment bar holes 73. To change the position of the bar 72 relative to the lift member 68, the user pulls on the internal plunger 77 to remove it from the adjustment bar hole 73. Once the plunger 77 is clear of the hole 73, the bar 72 is slid inward, or outward, to align another of the plurality of holes 73 in the bar 72 with the hole 67 located in the lift member 68. The plunger 77 is then released to snap back into the holes 67, 73. Adjustment of the position of the two wheel support assemblies 70, thereby increasing or decreasing the distance between the two roller assemblies 74 (see dimension “D” shown in FIG. 1), allows the device 15 to safely and ergonomically support wheels of varying sizes.

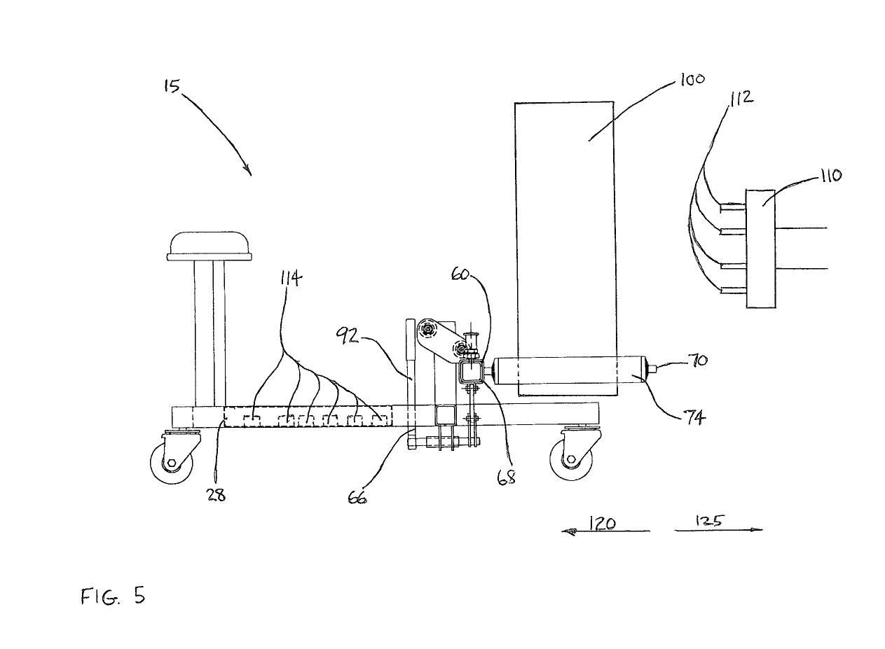

FIG. 5 illustrates the use of the device 15 designed to assist the changing of a vehicle wheel according to a first embodiment of the present invention. The device 15 is shown supporting a wheel 100 that has just been removed from (or, conversely, that is just about to be placed on) an axle hub 110. The wheel 100 was removed from the axle hub 110 by completing the following series of steps:

(1) With the lifting assembly 66 in the “down” position, the roller assemblies 74 were adjusted, via the process discussed with respect to FIG. 4, in order to appropriately position them to support the wheel 100.

(2) The plurality of lug nuts 114 were removed from the matching plurality of lugs 112 and placed for temporary storage in the integral tool tray 28.

(3) The lifting assembly 66 was utilized to drive the wheel support assembly 60 upward (i.e. the user exerted the required amount of force on the lift lever 92). The upward movement of the horizontal lift member 68, the wheel support roller assemblies 70 (i.e. the roller assemblies 74), and the wheel 100 transferred the weight of the wheel 100 from the lugs 112 to the device 15.

(4) While continuing to exert the required force on lever 92, the user caused the device 15 to travel in the direction of arrow 120 such that the wheel 100 was moved clear of the axle hub 110 and the lugs 112.

(5) The user lowered the lifting assembly 60 by gradually reducing the amount of force being exerted on the lever 92 until the lifting assembly 66 returned to the “down” position.

Once Step (5) has been completed, the device 15 and the wheel 100 may be easily moved as a unit by the user to complete any necessary tire repair/replacement processes.

The wheel 100 can be placed on the axle hub 110 by completing the following series of steps:

(1) The user raises the lifting assembly 60 by exerting the required amount of force on the lever 92 until the lifting assembly 66 achieves the appropriate “up” position (i.e. the height of the center of the wheel 100 matches that of the center of the axle hub 110/lugs 112).

(2) The user moves the device 15 in the direction of arrow 125 such that the wheel 100 engages the axle hub 110 and the lugs 112. As the wheel 100 approaches the hub 110 and the lugs 112, the roller assemblies 74 allow the user to slightly rotate the wheel 100 to precisely align the the clearance holes in the wheel's rim with the lugs 112.

(3) The plurality of lug nuts 114 are taken from their temporary storage location in the integral tool tray 28 and replaced on the matching plurality of lugs 112.

(4) The lift assembly 66 is lowered to the “down” position (i.e. the user gradually reduces the force being exerted on the lift lever 92). The downward movement of the horizontal lift member 68, the wheel support roller assemblies 70 (i.e. the roller assemblies 74), and the wheel 100 transfers the weight of the wheel 100 from the device 15 to the lugs 112.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

We claim:

1. A device to assist in the application and removal of a vehicle wheel to a vehicle hub, comprising:
a rigid frame assembly for ground support;
a seat assembly mounted at one end of said frame assembly for seating a user;
a wheel support assembly mounted at another end of said frame assembly for supporting a vehicle wheel in a vertical orientation; and
a lifting assembly in operative engagement with said wheel support assembly for selectively applying and removing said vehicle wheel to/from said vehicle hub while continuously maintaining said vehicle wheel in said vertical orientation.

2. The device to assist in the application and removal of a vehicle wheel to a vehicle hub according to claim 1, wherein said wheel support assembly further comprises a pair of parallel rollers spaced closer than a diameter of the vehicle wheel for carrying said wheel there between.

3. The device to assist in the application and removal of a vehicle wheel to a vehicle hub according to claim 2, wherein said lifting assembly further comprises a lever for gripping by said user.

4. The device to assist in the application and removal of a vehicle wheel to a vehicle hub according to claim 3, wherein said lifting assembly further comprises a vertical member, a vertical travel load bearing assembly supporting said wheel support assembly and adapted for riding up and down along said vertical member thereby elevating/lowering said wheel support assembly, and a linkage inclusive of a lower link and upper link pivotally joined together and in operative engagement between said lever and said vertical travel load bearing assembly for driving said vertical travel load bearing assembly in response to operation of said lever.

5. The device to assist the changing of a vehicle wheel according to claim 1, wherein said rigid frame assembly further comprises a plurality of casters for wheeled ground support.

6. The device to assist the changing of a vehicle wheel according to claim 1, wherein said frame assembly further comprises an integral tray for the temporary storage of tools, lug nuts, etc.

7. The device to assist the changing of a vehicle wheel according to claim 5, wherein said seat assembly further comprises a seating surface positioned at an ergonomic height above said plurality of casters to allow a user to propel said device by foot while in a seated position, and also to push said device by hand via said seating surface while standing.

8. The device to assist the changing of a vehicle wheel according to claim 2, wherein said wheel support roller assemblies extend in parallel forward and are driven by said lifting assembly along a vertical axis with no horizontal motion.

9. The device to assist the changing of a vehicle wheel according to claim 4, wherein said vertical travel load bearing assembly further comprises a pair of roller bearings with center shafts joined by a pair of side plates, whereby said vertical travel load bearing assembly surrounds said vertical member.

10. The device to assist the changing of a vehicle wheel according to claim 2, wherein each of said two wheel support roller assemblies further comprises:
an adjustment bar possessing a plurality of regularly spaced, vertically oriented holes; and
a roller assembly fixedly attached proximate an end of said adjustment bar such that a center axis of said roller assembly is perpendicular to a center axis of said adjustment bar, and said center axis of said roller assembly is also perpendicular to a center axis of any of said plurality of holes in said adjustment bar.

11. The device to assist the changing of a vehicle wheel according to claim 10, wherein said two wheel support roller assemblies are slidably engaged with said horizontal lift member and adjustable horizontally;
whereby a horizontal spacing between said two wheel support roller assemblies can be varied to accommodate a range of wheel sizes/diameters.

12. The device to assist the changing of a vehicle wheel according to claim 10, further comprising locking means for fixing a relative position between said two wheel support roller assemblies and said horizontal lift member.
